(19) United States
(12) Patent Application Publication
(10) Pub. No.: US 2021/0115957 A1
(43) Pub. Date: Apr. 22, 2021

(54) DUAL SIDED FASTENER DEVICE AND KIT

(71) Applicant: Edward Harmen, McKinney, TX (US)

(72) Inventor: Edward Harmen, McKinney, TX (US)

(21) Appl. No.: 16/654,004

(22) Filed: Oct. 16, 2019

(51) Int. Cl. F16B 15/00

(52) U.S. Cl. CPC F16B 15/0007

(57) ABSTRACT

A dual sided fastener kit including at least one dual sided fastener member and at least one fastener head attachment. The at least one dual sided fastener member attaches a target object to a source object. The dual sided fastener member includes a first side and a second side separated by a middle disc element. The first side and the second side each include a fastener end for insertion into a target object or a source object. The at least one fastener head attachment member includes a hollow tube attached to a head disc element for aiding in the insertion of a fastener end into a target object or a source object. The fastener head attachment member covers a fastener end at either the first side or second side for aiding in the insertion of the fastener end which is located at an opposite end from the covered fastener end.

### FIELD OF THE INVENTION

Embodiments described herein generally relate to fasteners, and more particularly to a dual sided fastener.

### BACKGROUND OF THE INVENTION

Hanging any object on the wall in an interior setting generally requires the use of a nail in order to hang or secure something permanently. Unfortunately, not all objects are specifically designed for use with a nail, and double-sided sticky strips are only a temporary solution and cannot withstand the weight of most objects. Failed attempts at hanging items on a flat surface can create significant safety hazards and put items at risk for loss or damage. Placing any frame or piece of art precariously on nails also carries the risk of it becoming lopsided. Hence, an improved mechanism for attaching or hanging an item from a wall is needed.

### BRIEF DESCRIPTION OF THE DRAWINGS

The various advantages of the embodiments of the present disclosure will become apparent to one skilled in the art by reading the following specification and appended claims, and by referencing the following drawings, in which:

FIG. 1 shows an exemplary view a dual sided fastener device according to an embodiment of the present disclosure.

FIG. 2 shows another exemplary view of a dual sided fastener device according to an embodiment of the present disclosure.

FIG. 3 shows another exemplary view of a dual sided fastener device according to an embodiment of the present disclosure.

FIG. 4 shows another exemplary view of a dual sided fastener device according to an embodiment of the present disclosure.

FIG. 5 shows another exemplary view of a dual sided fastener device according to an embodiment of the present disclosure.

FIG. 6 shows an exemplary view of a fastener head attachment according to an embodiment of the present disclosure.

FIG. 7 shows an exemplary view of a fastener head attachment attached to a dual sided fastener device according to an embodiment of the present disclosure.

FIG. 8 shows an exemplary view of another head attachment attached to a dual sided fastener device according to an embodiment of the present disclosure.

### SUMMARY OF THE INVENTION

Exemplary embodiments disclosed herein describe a dual sided fastener kit including at least one dual sided fastener member and at least one fastener head attachment. The at least one dual sided fastener member attaches a target object to a source object. The dual sided fastener member includes a first side and a second side separated by a middle disc element. The first side and the second side each include a fastener end for insertion into a target object or a source object. The at least one fastener head attachment member includes a hollow tube attached to a head disc element for aiding in the insertion of a fastener end into a target object or a source object. The fastener head attachment member covers a fastener end at either the first side or second side for aiding in the insertion of the fastener end which is located at an opposite end from the covered fastener end.

In some exemplary embodiments, the fastener end is at least one from the group comprising a nail fastener end, a tack fastener end and a screw fastener end.

In some exemplary embodiments, a plurality of dual sided fastener members and a plurality of fastener head attachments.

In some exemplary embodiments, each dual sided fastener member of the plurality of dual sided fastener members has a different fastener end at the first side of the member and the second side of the member.

In some exemplary embodiments, each dual sided fastener member of the plurality of dual sided fastener members has a same fastener end at the first side of the member and the second side of the member.

In some exemplary embodiments, the plurality of dual sided fastener members include members having a different fastener end at the first side of the member and the second side of the member and members having a same fastener end at the first side of the member and the second side of the member.

In some exemplary embodiments, the head disc element includes a flathead disc.

In some exemplary embodiments, the head disc element includes a Philips head disc.

In some exemplary embodiment, the plurality of fastener head attachments includes at least one fastener head attachment having a flathead disc.

In some exemplary embodiments, the plurality of fastener head attachments includes at least one fastener head attachment having a Philips head disc.

In some exemplary embodiments, the flathead disc is used to insert a nail fastener into a target object or a source object.

In some exemplary embodiments, the Philips head disc is used to insert a screw fastener end into a target object or a source object.

Other exemplary embodiments disclosed herein describe a dual sided fastener device including a dual sided fastener member for attaching a target object to a source object, the dual sided fastener member including a first side and a second side separated by a middle disc element, wherein the first side and the second side each include a fastener end for insertion into a target object or a source object.

In some exemplary embodiments, the fastener end at the first side of the member receives a fastener head attachment for aiding in the insertion of the fastener end at the second side of the member into a target object or a source object.

In some exemplary embodiments, the fastener end at the second side of the member receives a fastener head attachment for aiding in the insertion of the fastener end at the first side of the member into a target object or a source object.

In some exemplary embodiments, the fastener end is at least one from the group comprising a nail fastener end, a tack fastener end and a screw fastener end.

In some exemplary embodiments, the fastener end at the first side and the second side of the member are different.

In some exemplary embodiments, the fastener end at the first side and the second side of the member are identical.

### DETAILED DESCRIPTION

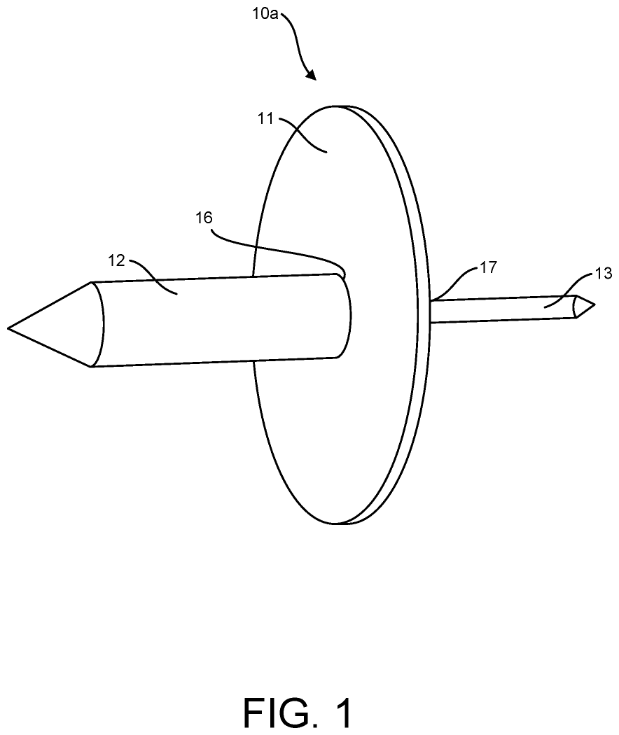

The present disclosure relates to a dual sided fastener kit which offers a convenient solution for hanging items on a wall with one attempt. The dual sided fastener kit includes a variety of dual sided fastener devices and a variety of fastener head attachments. As illustrated in FIGS. 1-8, the dual sided fastener kit (“the kit”) includes at least one dual sided fastener device (“the device”) 10 (i.e., 10a-10f), and at least one fastener head attachment 15 (i.e., 15a, 15b).

Each device 10 may be made out of a hard, rigid material, such as, for example, steel. Each device includes a first side 16 and second side 17 and a middle disc 11. Each side may be either a target fastener end or a source fastener end. The target fastener end may attach to an object, such as, for example, a wall hanging or a frame. The source fastener end may attach the target object to another object, such as, for example, a wall. Moreover, each side may include the end structure (i.e., the part of the fastener that is completely inserted into another object) of a mechanical fastener, such as, for example, a nail, tack, or a screw.

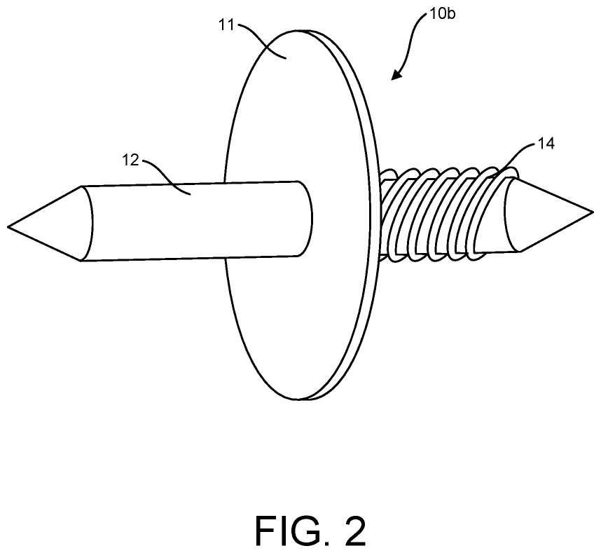

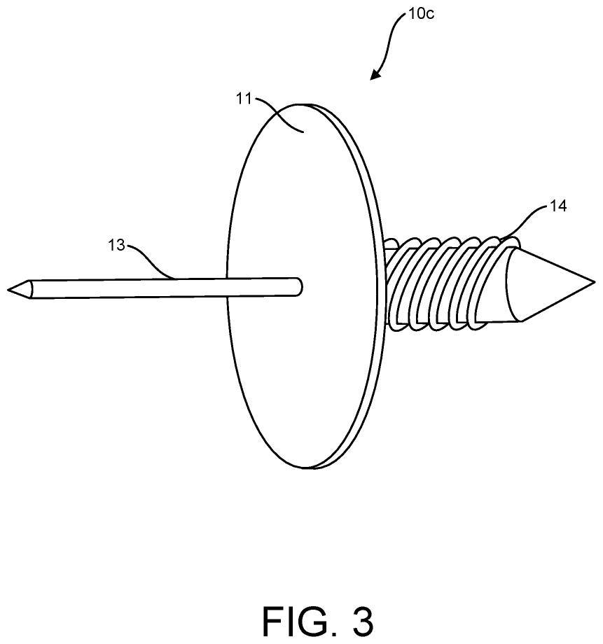

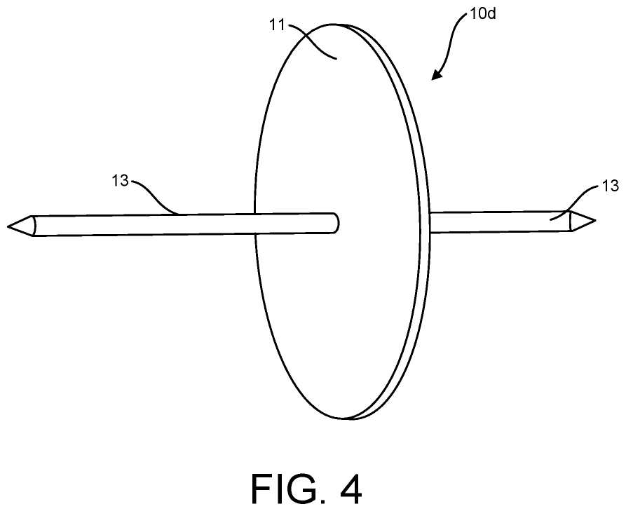

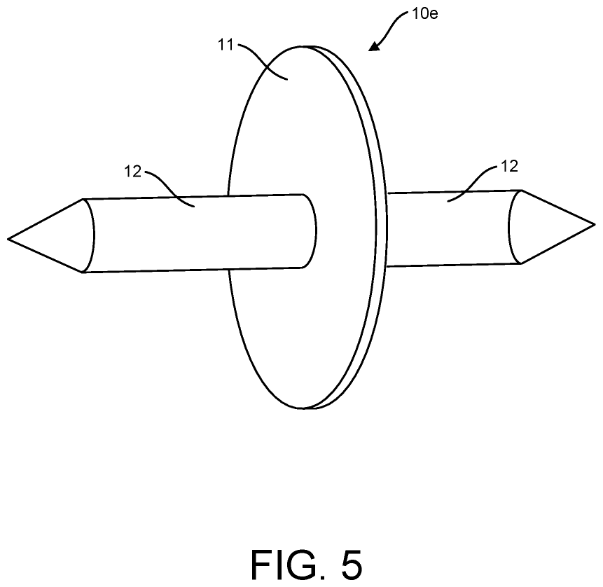

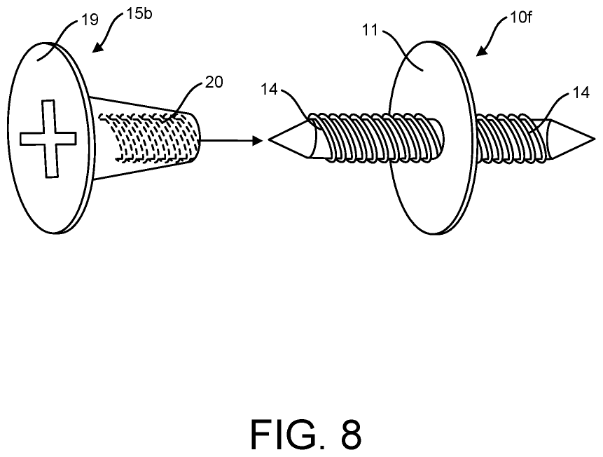

In FIG. 1, the device 10a (nail-tack) includes a nail fastener end 12 and a tack fastener end 13. In FIG. 2, the device 10b (nail-screw) includes a nail fastener end 12 and a screw fastener end 14. In FIG. 3, the device 10c (tack-screw) includes a tack fastener end 13 and a screw fastener end 14. In FIG. 4, the device 10d (tack-tack) includes a tack fastener end 13 and a tack fastener end 13. In FIG. 5, the device 10e (nail-nail) includes a nail fastener end 12 and a nail fastener end 12. In FIG. 8, the device 10f (screw-screw) includes a screw fastener end 14 and a screw fastener end 14.

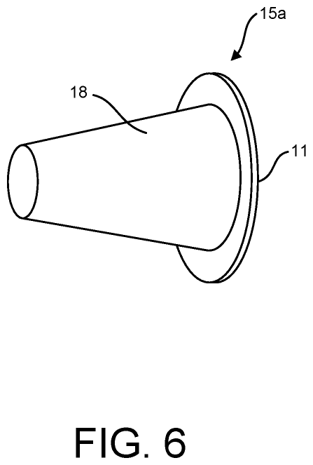

The fastener head attachments 15 may be used to attach a fastener end (i.e., target or source) to a target object or a source object. The fastener head attachment 15a may include, for example, a flathead disc 11 attached to a hollow tube 18, which is reminiscent of a nail head, as shown in FIG. 6. Further, the fastener head attachment 15b may include a Philips head disc 19 attached to a tapered, internally threaded hollow tube, which is reminiscent of a screw head, as shown in FIG. 8. The particular type of fastener head attachment 15 used, if any, to insert a fastener end into an object depends on the type of fastener end.

Each fastener end may be attached in a different way. For example, typically, nails are inserted into an object using, for example, a hammer or a nail gun, which applies force to the flathead end of a nail. Screws are typically inserted into an object using, for example, a Philips screwdriver, which is inserted into the head of a screw which typically includes a cross-like enclosure for receiving the Philips screwdriver to rotate the screw for insertion into an object. Tacks are typically inserted by applying a push force, such as, for example, with an individual's hand.

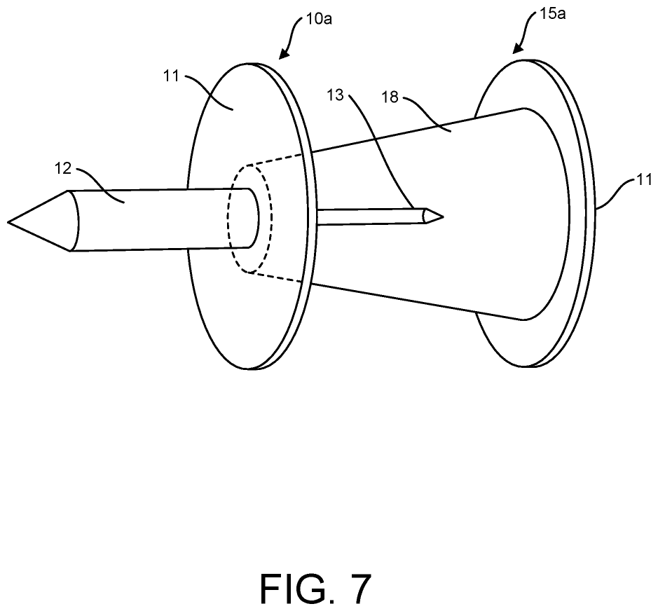

For the nail-tack device 10a (FIG. 1), the nail fastener end may be attached to a target or source by attaching fastener head attachment 15a over the tack fastener end 13, as shown in FIG. 7, and applying force (e.g., with a hammer or nail gun) to the disc 11 element of 15a to insert the nail fastener end 12 into a target or source object. Once the nail fastener end 12 is inserted into the desired object, the fastener head attachment 15a is removed and the tack fastener end 13 is inserted into the target object or the source object using, for example, an individual's hand. In a preferred embodiment, the nail fastener end 12 may be inserted into a wall (source object) and the tack fastener end 13 may be inserted into an which is desired to be attached to the wall.

For the nail-screw device 10b (FIG. 2), the nail fastener end may be attached to a target or source object by attaching fastener head attachment 15a over the screw fastener end 14, and applying force to the disc 11 element of 15a to insert the nail fastener end 12 into a target or source object. The screw fastener end may be inserted into a target or source object by attaching fastener head attachment 15b over the nail fastener end 12, and applying a rotational force, using a Philips screwdriver, to the screw fastener end to insert the screw into a target or source object.

In some embodiments, such as, nail-screw device 10b (FIG. 2), nail-nail device 10e (FIG. 5), and screw-screw device 10f (FIG. 8), where both fastener ends require a tool for insertion into an object, such as, for example, a hammer/nail gun or a screwdriver, only one of the fastener head attachments may be required for use. So, in the instance of the nail-screw device 10b, once one end of the device is attached with the appropriate fastener head attachment, the other end may be attached to an object without requiring its corresponding fastener head attachment. If screw fastener end 14 is attached to a target object, such as, for example, a wall hanging, using fastener head attachment 15b, the nail fastener end 12 cannot be attached to a source object, such as, for example, a wall, using fastener head attachment 15a, since, the screw fastener end is already attached to an object. In this scenario, the nail fastener end may be attached to the wall by applying force directly to the target object with the nail fastener end extending outward from the target object for insertion into the source object.

For the tack-screw device 10c (FIG. 3) the screw fastener end may first be attached to a target or source object by attaching fastener head attachment 15b over tack fastener end 13 and applying force to the Philips head 19. Thereafter the tack fastener end 13 may be attached to a target object by aligning the target object in front of the tack fastener end and applying force to the target object so that the tack fastener end is inserted into the target object. To insert the tack fastener end into a source object, apply force directly to the target object with the tack fastener end extending outward from the target object for insertion into the source object.

For the tack-tack device 10d (FIG. 4), each tack fastener end 13 may be inserted into an object without a fastener head attachment. In a preferred embodiment, one tack fastener end is first inserted into a target object by applying force to disc element 11 of 10d. Thereafter, the other tack fastener end is inserted into the source object by applying force directly to the target object with the other tack fastener end extending outward from the target object for insertion into the source object

For the nail-nail device 10e (FIG. 5), one nail fastener end 12 is first inserted into a target or source object by attaching the fastener head attachment 15a over the other nail fastener end. Thereafter, the other nail fastener end 12 is attached to the other object by applying force directly to the target object.

For the screw-screw device 10f (FIG. 8), one screw fastener end 14 is first inserted into a target or source object by attaching the fastener head attachment 15b over the other screw fastener end. Thereafter, the other screw fastener end 14 may be attached to an object using a screw-on attachment.

Although the embodiments described in the disclosure are directed to a nail fastener end, tack fastener end and screw fastener, other fastener ends may be used in the implementation of the dual sided fastener device 10. In addition, although the fastener head attachment 15 was described as having a flathead disc or a Philips head disc, other disc heads may be used in the implementation of the fastener head attachment 15.

The disclosed embodiments are not inclusive and many other modifications and variations will be apparent to someone of ordinary skill in the art with construction skills in the related arts. Together the descriptions and accompanying illustrations seek to provide an explanation of the basic principles of the embodiment and its application. It is therefore intended that the specification and embodiments be considered as exemplary only.

Those skilled in the art will appreciate from the foregoing description that the broad techniques of the embodiments of the present invention may be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

What is claimed is:

1. A dual sided fastener kit comprising:
at least one dual sided fastener member for attaching a target object to a source object, the dual sided fastener member including a first side and a second side separated by a middle disc element, wherein the first side and the second side each include a fastener end for insertion into a target object or a source object; and
at least one fastener head attachment member including a hollow tube attached to a head disc element for aiding in the insertion of a fastener end into a target object or a source object, wherein the fastener head attachment member covers a fastener end at either the first side or second side for aiding in the insertion of the fastener end which is located at an opposite end from the covered fastener end.

2. The kit of claim 1, wherein the fastener end is at least one from the group comprising a nail fastener end, a tack fastener end and a screw fastener end.

3. The kit of claim 2, further comprising a plurality of dual sided fastener members and a plurality of fastener head attachments.

4. The kit of claim 3, wherein each dual sided fastener member of the plurality of dual sided fastener members has a different fastener end at the first side of the member and the second side of the member.

5. The kit of claim 3, wherein each dual sided fastener member of the plurality of dual sided fastener members has a same fastener end at the first side of the member and the second side of the member.

6. The kit of claim 3, wherein the plurality of dual sided fastener members include members having a different fastener end at the first side of the member and the second side of the member and members having a same fastener end at the first side of the member and the second side of the member.

7. The kit of claim 1, wherein the head disc element includes a flathead disc.

8. The kit of claim 1, wherein the head disc element includes a Philips head disc.

9. The kit of claim 3, wherein the plurality of fastener head attachments includes at least one fastener head attachment having a flathead disc.

10. The kit of claim 3, wherein the plurality of fastener head attachments includes at least one fastener head attachment having a Philips head disc.

11. The kit of claim 7, wherein the flathead disc is used to insert a nail fastener end into a target object or a source object.

12. The kit of claim 8, wherein the Philips head disc is used to insert a screw fastener end into a target object or a source object.

13. A dual sided fastener device comprising:
a dual sided fastener member for attaching a target object to a source object, the dual sided fastener member including a first side and a second side separated by a middle disc element, wherein the first side and the second side each include a fastener end for insertion into a target object or a source object.

14. The device of claim 13, wherein the fastener end at the first side of the member receives a fastener head attachment for aiding in the insertion of the fastener end at the second side of the member into a target object or a source object.

15. The device of claim 13, wherein the fastener end at the second side of the member receives a fastener head attachment for aiding in the insertion of the fastener end at the first side of the member into a target object or a source object.

16. The device of claim 13, wherein the fastener end is at least one from the group comprising a nail fastener end, a tack fastener end and a screw fastener end.

17. The device of claim 13, wherein the fastener end at the first side and the second side of the member are different.

18. The device of claim 13, wherein the fastener at the first side and the second side of the member are identical.
